(19) United States
(12) Patent Application Publication
(10) Pub. No.: US 2005/0008097 A1
(43) Pub. Date: Jan. 13, 2005

(54) Coded modulation scheme for a wirelesss communication system and methods thereof

(76) Inventors: Tjeng Thiang Tjhung, Burgundy Crescent, Singapore (SG); Hari Krishna Garg, Kent Vale B Singapore (SG); Wei Tian, Blk 525 Choa Chu Kang Street, Singapore (SG)

Correspondence Address: George D Liu;Lawrence Y D Ho & Associates, 2101 Crystal Plaza Arc, PMB 400, Arlington, VA, 22202, US

(21) Appl. No.: 10/486,887

(22) PCT Filed: Aug. 17, 2001
(86) PCT No.: PCT/SG01/00165

(51) Int. Cl. H04L 27/12

(52) U.S. Cl. 375/302

(57) ABSTRACT

A wireless communication system (10), an encoding method (300) for encoding a binary input signal and a decoding method (800) for decoding a coded baseband signal within the wireless communication system (10) are described. The system (10) has an encoding section (12) and a decoding section (14). The encoding section (12) has a mapper (26) for mapping bits into symbols, and an encoder (28), coupled to the mapper (26), for encoding the symbols to corresponding integers modulo M, where M is an arbitrary predetermined integer. Coded symbols are derived from the corresponding integers. At the decoding section (14), a decoder (40) decodes an output phasor stream of a coded baseband signal to derive an estimate of a codeword. Thereafter, a demapper (42) demaps the estimate of the codeword to derive the bits from decoded symbols.

### FIELD OF THE INVENTION

The present invention relates to coded modulation schemes for voice or data signals in wireless communication systems. In particular, this invention relates to a coded modulation scheme for a wireless communication system having channels adversely affected by fading and methods thereof.

### BACKGROUND OF THE INVENTION

In recent years, to realize wireless Internet communications, much effort has been devoted to developing reliable wireless communication systems. Data transmission in such systems is adversely affected by environmental factors such as multipath fading. In multipath fading, a desired signal travels to a receiver along multiple propagation paths due to reflections and scattering by obstacles. Consequently, components of the desired signal from the multiple propagation paths weaken or reinforce each other to cause signal level fluctuations at the receiver.

Known techniques to resolve or alleviate multipath fading include diversity processing based upon repeat transmissions in time and frequency or multiple reception by geometrically space-apart antennae. Alternatively, forward error correcting (FEC) coding can be used to improve the performance of wireless communication systems. However, FEC coding is performed at the expense of an increased bandwidth. To achieve the benefit of FEC coding without the increased bandwidth, recently developed coded modulation techniques can be applied instead.

Coded modulation is a technique that combines coding and modulation schemes without compromising on bandwidth efficiency. Application examples of coded modulation range from voice-band modems for telephone lines to space communication systems. In some mature applications, coded modulation has been adopted as national or international standards for communication protocols.

In terms of code structure, coded modulation can be classified into two schemes: block-coded modulation (BCM) and trellis-coded modulation (TCM). In a BCM scheme, block codes are combined with a chosen modulation signal constellation, whereas in TCM, convolutional or trellis codes are combined with a chosen modulation signal constellation. One advantage of coded modulation over traditional error control coding is that code redundancy is provided by signal set expansion. Such code redundancy alleviates rate loss or the need for an increased bandwidth. The coded modulation schemes can transmit several (say n) different symbols, each represented by different states of magnitude and phase of the carrier. Thus log₂ (n) information bits can be transmitted per symbol period.

Various TCM schemes have been proposed for channels affected by multipath fading. However, the use of BCM schemes over such channels as an alternative to TCM schemes has not been much reported in the literature. Typically, the BCM schemes applied in existing wireless communication systems use expensive computer search methods to find block codes with good error performance.

A number of trellis codes have been devised in existing TCM schemes starting with those of Ungerboeck (Ungerboeck, G., “Trellis-Coded Modulation with Redundant Signal Sets-Part 1 Introduction,” IEEE Communications Magazine, February 1987, pp.5-11) Some of these trellis codes have been adopted widely in the high-speed telephone modem industry. However, a disadvantage of such existing TCM schemes is the complexity in decoding resulting trellis codes. Furthermore, decoding delays and memory requirements of these existing TCM schemes are unsuitable for high speed or low cost applications. In BCM schemes there is a modest fixed delay, whereas in TCM schemes there is a delay of several times that of an encoder's memory. Besides computational complexity due to the number of arithmetic operations, a trellis decoder requires survivor path memories that may be very long with constraint length. In a BCM scheme, memory requirements are limited to the block length.

Recently, Baldini and Farrell also proposed a BCM scheme that is based on rings of integers modulo-q (F. R. Baldini and P. G. Farrell, “Multilevel block subcodes for coded phase modulation,” Electronic Letters, Vol. 30, No. 12, June 1994.) However, the input and output of their multilevel encoder are over the same ring and such a ring can only be of the order of 2^{m}. Such a multilevel encoder is therefore limited and does not have the flexibility beyond the order of 2^{m}. Furthermore, hard decision decoding typically applied in such a BCM scheme lowers the performance compared with soft decision decoding. Hence, in the multilevel encoder proposed by Baldini and Farrell, code construction is only performed over a finite field and not with soft decision decoding.

Therefore, a need clearly exists for wireless communication systems to have improved data encoding and decoding schemes to overcome or at least alleviate channel fading such as, for example, Rayleigh fading.

### BRIEF SUMMARY OF THE INVENTION

The present invention seeks to provide a wireless communication system, a method for encoding a binary input signal and a method for decoding a coded baseband signal within the wireless communication system.

Accordingly, in one aspect, the present invention provides a wireless communication system comprising:
a mapper for mapping a plurality of bits into a plurality of symbols, each of the plurality of symbols being associated with one or more of the plurality of bits;
and
an encoder, coupled to the mapper, for encoding the plurality of symbols to a corresponding plurality of integers modulo M to derive a plurality of coded symbols at the encoder output, the M being an arbitrary predetermined integer.

In another aspect, the present invention provides, in a wireless communication system, a method for encoding a binary input signal, the method comprising the steps of:
receiving a plurality of bits of the binary input signal;
mapping the plurality of bits into a plurality of symbols, each of the plurality of symbols being associated with one or more of the plurality of bits;
and
encoding the plurality of symbols to a corresponding plurality of integers modulo M to derive a plurality of codewords, the M being an arbitrary predetermined integer.

In yet another aspect, the present invention provides a wireless communication system comprising:
a decoder for decoding an output phasor stream of a coded baseband signal to derive an estimate of a codeword, the output phasor stream having a plurality of symbols encoded therein and corresponding to the codeword, each of the plurality of symbols being associated with one or more of a plurality of bits;
and
a demapper for demapping the estimate of the codeword to derive the plurality of bits from decoded symbols.

In a further aspect, the present invention provides, in a wireless communication system, a method for decoding a coded baseband signal, the method comprising the steps of:
decoding an output phasor stream of the coded baseband signal to derive an estimate of a codeword, the output phasor stream having a plurality of symbols encoded therein and corresponding to the codeword, each of the plurality of symbols being associated with one or more of a plurality of bits;
and
demapping the estimate of the codeword to derive the plurality of bits from decoded symbols.

### BRIEF DESCRIPTION OF THE DRAWINGS

A preferred embodiment of the present invention will now be more fully described, by way of example, with reference to the drawings of which:

FIG. 1 illustrates a general block diagram of a wireless communication system having an encoding section and a decoding section in accordance with the present invention;

FIG. 2 is a general block diagram of an encoder of the encoding section of FIG. 1;

FIG. 3 is an encoder trellis for the encoder of FIG. 2;

FIG. 4 illustrates block interleaving of encoded symbols within the encoding section of FIG. 1;

FIG. 5 is a flowchart illustrating a method for encoding a binary input signal by the encoding section of FIG. 1;

FIG. 6 illustrates a Viterbi decoding trellis when correctly decoding using the decoding section of FIG. 1;

FIG. 7 illustrates incorrect decoding by the decoding section of FIG. 1 when fading and additive white Gaussian noise (AWGN) impairments are excessive;

FIG. 8 is a flowchart illustrating a method for decoding a coded baseband signal by the decoding section of FIG. 1;

FIG. 9 is a graph of code error probability (CEP) as a function of signal to noise ratio;

FIG. 10 is a graph of CEP as a function of fade rate; and

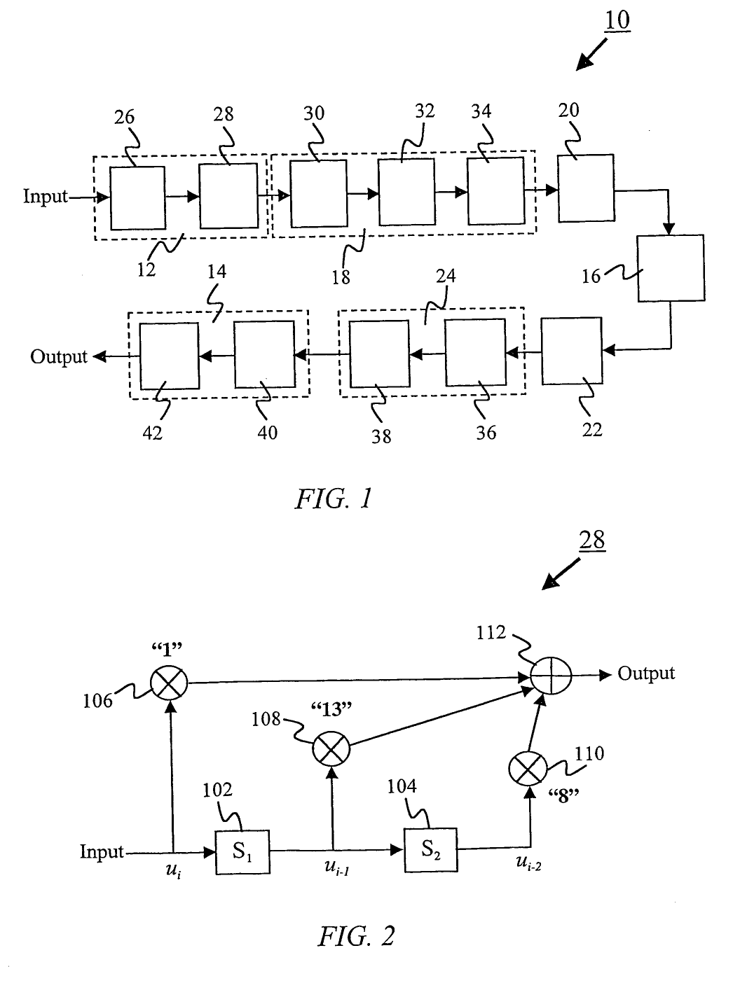

FIG. 1 is a graph of CEP as a function of interleaving depth.

### DETAILED DESCRIPTION OF THE DRAWINGS

A wireless communication system, a method for encoding a binary input signal and a method for decoding a coded baseband signal within the wireless communication system in accordance with a preferred embodiment of the invention are described. In the following description, details are provided to describe the preferred embodiment. It shall be apparent to one skilled in the art, however, that the invention may be practiced without such details. Some of these details may not be described at length so as not to obscure the invention.

There are many advantages of the invention. One advantage of the invention is that the wireless communication system applies an encoding scheme using block-coded modulation (BCM) without bandwidth expansion for signals communicated over fading channels such as Rayleigh fading channels.

Another advantage of the invention is that a code generator matrix for the encoding scheme is determined in a systematic and more efficient manner than existing computer search methods.

A further advantage of the invention is that codes generated by the encoding scheme allow soft decision Viterbi decoding that is computationally more efficient and has less decoding delay compared with existing trellis coded modulation (TCM) schemes.

Yet another advantage of the invention is that improvements are achievable for the wireless communication system in terms of code error probability (CEP) without adverse bandwidth expansion.

Referring now to FIG. 1, a general block diagram illustrates a wireless communication system 10 having an encoding section 12 and a decoding section 14 in accordance with the present invention. Signals are communicated from the encoding section 12 to the decoding section 14 over one or more channels 16. These channels 16 may be affected by channel impairments such as Rayleigh fading.

The wireless communication system 10 comprises a symbol modulator 18 coupling the encoding section 12 to a transmitting section 20. Input to the encoding section 12 is a plurality of data bits. The plurality of bits are then encoded within the encoding section 12 and output from the encoding section 12 is provided to the symbol modulator 18. Modulated symbols from the symbol modulator 18 are mixed with one carrier signal within the transmitting section 20 to derive a modulated carrier signal. The transmitting section 20 then transmits the modulated carrier signal over the channels 16 to a receiving section 22.

Upon receiving the modulated carrier signal, the receiving section 22 down-converts the carrier signal to a coded baseband signal. The coded baseband signal, coded with one or more symbols, are then symbol demodulated by a symbol demodulator 24. Thereafter, demodulated symbols from the symbol demodulator 24 are then provided to the decoding section 14 to derive a plurality of bits as output. The plurality of bits corresponds to the input to the encoding section 12.

For every block of N binary source bits or plurality of bits, a mapper 26 of the encoding section 12 maps every n bits into a q-ary output symbol, q=2ⁿ. Specifically, the mapper 26 slices the N binary source bits into consecutive block of

$$\frac{N}{n}$$

symbols, where n is a factor of N. Hence, for N binary source bits represented by b=[b₁, b₂, . . . , b_{N}], the output symbols are represented by d=[d₁, d₂, . . . d_{N/n}], wherein d₁=b₁+2b₂+ . . . +2ⁿ⁻¹bₙ, and each k^{th} output symbol or dₖ is defined similarly.

A generator matrix G of an encoder 28 of the encoding section 12 is an N/n by N matrix. The encoder 28 is non-linear and is illustrated with a general block diagram in FIG. 2. The encoder 28, implemented as a shift register, has two delay elements 102,104. Input symbols are shifted into the encoder 28 from left to right Constants of 1,13 and 8 at multipliers 106,108,110 multiply the data at the various stages of the encoder 28, respectively. The resulting numbers from these multipliers 106,108,110 are added at an adder 112 to produce the overall output symbols. This encoding operation is performed modulo 15.

The elements for such a generator matrix G are defined over Z(M), a ring of integers modulo M, where M is an arbitrary predetermined integer that is greater than q=2ⁿ. Consequently, an increase in codeword distance is expected. A codeword generated by the encoder 28 is denoted by c=[c₁, c₂. . . , c_{N}] with each k^{th} element or cₖ tang value in Z(M). Therefore, an input of N binary source bits is converted to N M-ary symbols and bandwidth is thereby conserved with such an encoding method.

Code construction by the encoder 28 is based upon the following equation:
c=d\mathring{×}_{M}G (1)
where \mathring{×}_{M} denotes product modulo M.

In describing the code construction, n=2 is used as an exemplary illustration, with the N binary source bits b=[b₁, b₂, . . . , b_{N}], in which bₖ takes values in Z₂, the ring of integers modulo 2. Output from the mapper 26, d=[d₁, d₂, . . . , d_{N/n}] with elements in d take values in Z₄ are encoded into a codeword c=[c₁, c₂, . . . , c_{N}], where dₖ ∈Z₄, and cₖ ∈Z_{M}. In this exemplary illustration, the generator matrix G is an N/2-by-N generator matrix with elements in Z(M).

In Z₂ or GF(2), it is well known that an (m, k) cyclic code based on the irreducible polynomial can be defined in GF(2). However, in the ring Z(M), the corresponding irreducible polynomial defined in Z(M) has to be found. The following procedure describes how to find the generator polynomial over Z(M).

Starting with the fundamental theorem of arithmetic stating that a composite integer M can be uniquely factored as (standard factorisation of M),

$$M = {\prod }_{i = 1}^{t} {q}_{i} , \qquad ( 2 )$$

where qᵢ=pᵢ^{a}^{ᵢ}, pᵢ is the i-th prime factor and aᵢ is a positive integer exponent.

In the case for t=1, then M=qᵢ=pᵢ^{a} is first considered. Many existing cyclic codes have been found over GF(pᵢ), in which the generator polynomial, g₀(x) divides x^{m}−1, where m is the length of the codeword. However, the corresponding g(x) which divides x^{m}−1 over Z(qᵢ) can be found based upon the following equation:
x^{m}−1=g(x)h(x)mod qᵢ (3)
where g(x) and h(x) are defined modulo qᵢ and expressed in the p-adic form as follows:

$$g ( x ) = {\sum }_{j = 0}^{{a}_{i} - 1} {g}_{j} ( x ) {p}_{i}^{j} \qquad ( 4 )$$

$$\begin{matrix}h ( x ) = {\sum }_{j = 0}^{{a}_{i} - 1} {h}_{j} ( x ) {p}_{i}^{j} where & ( 5 ) \\ {g}_{j} ( x ) = {\sum }_{i = 0}^{l - 1} {g}_{i , j} {x}^{i} {g}_{i , j} ∈ GF ( {p}_{i} ) & ( 6 ) \\ {h}_{j} ( x ) = {\sum }_{i = 0}^{s - 1} {h}_{i , j} {x}^{i} {h}_{i , j} ∈ GF ( {p}_{i} ) & ( 7 )\end{matrix}$$

A detailed analysis and various proofs for the above can be found in Garg H. K., Digital Signal Processing Algorithms, CRC Press 1998 (Sections 6.2, 6.3 and 7,4). For example, to find the generator matrix G(8, 4) for M=4. Here G(8, 4) is a row 4, column 8 matrix, where 8 represents the block size N of the codeword. Since every n=2 bits is mapped into the q-ary symbol, the number of rows is N/n=8/2=4. The degree of the generator polynomial for the (m, k) cyclic code deg is determined by deg=m−k=N−N/n=4.

A primitive polynomial of degree 4 over GF(2) is x⁴+x+1. The degree 4 primitive polynomial over Z(4) is x⁴+2x²+3x+1. Therefore the generator matrix G is given as follows:

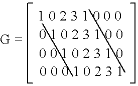

Preferably, the generator matrix is to be of the above-banded rectangular matrix because this kind of cyclic code have special trellis structure and can be easily decoded using the Viterbi algorithm In the banded rectangular matrix, the i-th row is a shifted version of the (i−1)-th row.

In the case where t is an arbitrary integer, and

$$M = {\prod }_{i = 1}^{t} {q}_{i}$$

is a composite integer, then given a polynomial A(x) with coefficients over Z(M), M=p₁^{a}^{₁}p₂^{a}^{_{2 . . .}} pₜ^{a}^{₁}. The polynomials A⁽¹⁾(x); i=1,2, . . . , t can be found by
A⁽ⁱ⁾(x)≡A(x)mod pᵢ^{a}^{₁} (8)

The above statement follows directly from application of the Chinese Remainder Theorem for integers and the definition of a polynomial. If the polynomials A⁽¹⁾(x) mod p₁^{a}^{₁} are already know, then the corresponding A(x) mod Z(M) has to be found.

Firstly, the polynomials are written as:

$$\begin{matrix}{A}^{( l )} ( x ) = {\sum }_{j = 0}^{m - 1} {a}_{ij} {x}^{j} mod {p}_{l}^{{a}_{l}} & ( 9 ) \\ {A}^{( k )} ( x ) = {\sum }_{j = 0}^{m - 1} {a}_{ij} {x}^{j} mod {p}_{k}^{{a}_{k}} & ( 10 )\end{matrix}$$

The polynomial A^{(i,j)}(x) mod p₁^{a}^{₁}pₖ^{a}^{ₖ} can be found by:

$${A}^{( i , j )} ( x ) = {\sum }_{j = 0}^{m - 1} {a}_{ik , j} {x}^{j} mod {p}_{l}^{{a}_{l}} {p}_{k}^{{a}_{k}} \qquad ( 11 )$$

where aᵢₖ^{ⱼ}=aᵢⱼ⊕aₖⱼ can be obtained by the Chinese Remainder Theorem for integers.

Following the same procedure as above, the polynomial A(x) with coefficients over Z(M), M=p₁^{a}^{₁}p₂^{a}^{_{2 . . .}} p₁^{a}^{₁} is determined from:
A(x)=A⁽¹⁾(x)⊕ A⁽²⁾(x)⊕ . . . ⊕ A^{(t)}(x) (12)

As another example, the generator matrix G(8, 4) for M=20 is used, where the degree of the generator polynomial is deg=m−k=4. Here M=20=2²0.5.

As it is already known from the earlier example that the degree 4 primitive polynomial over Z(4) is G₁(x)=x⁴+2x²+3x+1 and over Z(5) is G₂(x)=x⁴+x³+3x²+3. Based on the Chinese Remainder Theorem, the generator polynomial over Z(20) is G(x)=x⁴+16x³+18x²+15x+13. Therefore, the generator matrix is

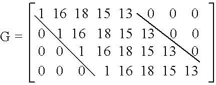

Code construction using shift registers that can be described by a code trellis is illustrated with the following example,

For a code with a generator matrix G(4, 2) for M=15, the generator matrix is found in the same way as for the generator matrix G(8, 4) for M=20. The degree 2 primitive polynomial over Z(3) is G₁(x)=x²+x+2 and over Z(5) is G₂(x)=x²+3x+3 are already known. Based on the Chinese Reader Theorem, the generator polynomial over Z(15) is G(x)=x²+13x+8. Therefore, the generator matrix is

$$G = [ \begin{matrix}1 & 13 & 8 & 0 \\ 0 & 1 & 13 & 8\end{matrix} ]$$

Then the codeword c is

$$c = d {⊗}_{M} G = ⌊ \begin{matrix}0 & 0 \\ 0 & 1 \\ 0 & 2 \\ 0 & 3 \\ ⋮ & ⋮ \\ 3 & 3\end{matrix} ⌋ \cdot [ \begin{matrix}1 & 13 & 8 & 0 \\ 0 & 1 & 13 & 8\end{matrix} ] = ⌊ \begin{matrix}0 & 0 & 0 & 0 \\ 0 & 1 & 13 & 8 \\ 0 & 2 & 11 & 1 \\ 0 & 3 & 9 & 9 \\ ⋮ & ⋮ & ⋮ & ⋮ \\ 3 & 12 & 3 & 9\end{matrix} ⌋ \qquad ( 13 )$$

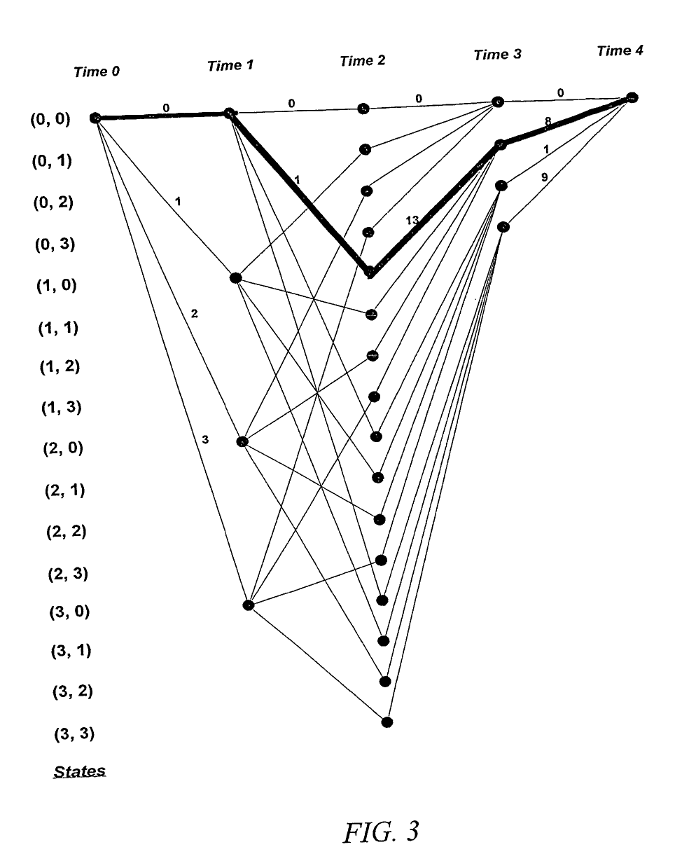

The state for the encoder 28 is defined as tie contents of shift registers, that is, sᵢ=(uᵢ₋₁, uᵢ₋₂) where {u₁} is the information sequence. For the encoder 28, it is convenient to use the trellis as shown in FIG. 3 to keep track of the state of the encoder 28 at each time. Suppose that the encoder 28 is initialed in the state (0, 0), and the 2-bit message (0, 1) is transmitted followed by a terminating string of (0, 0). Therefore, the transmitted codeword is cₙ=(0, 1, 13, 8).

Each branch of the trellis is labelled with the code symbol and the path in old shown in FIG. 3 illustrates the encoded codeword c from the encoder 28. The umber of possible states at time i=0, 1, . . . , 4 is, respectively, 1, 4, 16, 4, 1.

A flowchart of the encoding method 300 to encode a binary input signal as described in the above is illustrated in FIG. 5. The method begins at step 302 in which the encoding section 12 receives the binary input signal having a plurality of bits. Thereafter, the mapper 26 maps the plurality of bits into a plurality of symbols. Each of the plurality of symbols is associated with one or more of the plurality of bits.

The method 300 then continues to step 308 at which the encoder 28 encodes the plurality of symbols to a corresponding plurality of integers modulo M to derive a plurality of codewords. M is an arbitrary predetermined integer.

The encoding method ends with step 310 at which the plurality of codewords are modulated by the symbol modulator 18 and transmitted by the transmitting section 20.

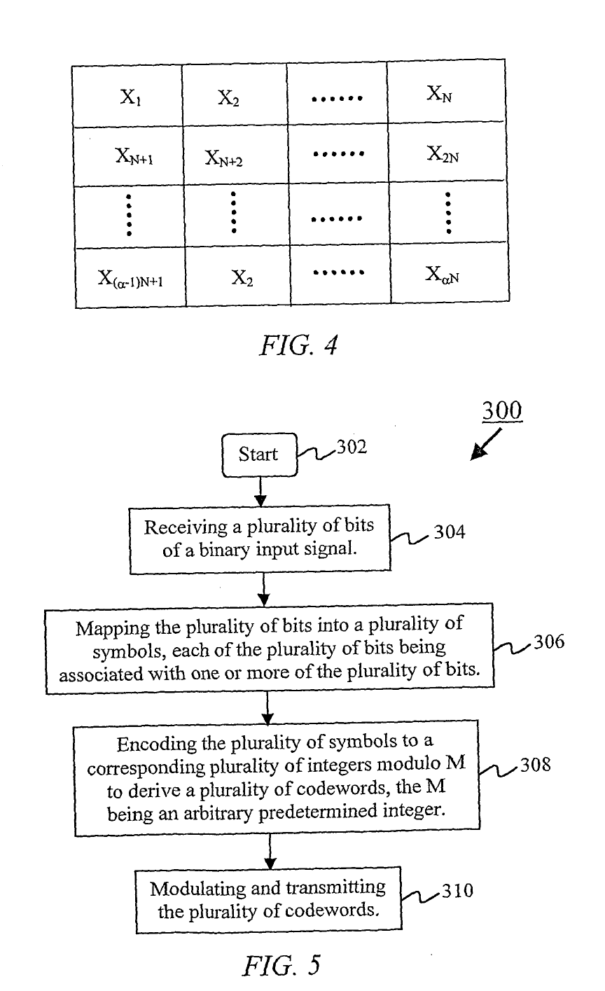

Following encoding of the plurality of bits, coded symbols are provided to the symbol modulator 18. The symbol modulator 18 comprises a phase modulator 30, a block interleaver 32 and a differential phase encoder 34. Operating on the codeword c, the phase modulator 30 transforms the codeword c to an output phasor block x=[x₁, x₂, . . . , x_{N}] with xₖ=exp{−j2πcₖ/M}. Thereafter, the block interleaver 32 interleaves the output phasor block x. The block interleaver 32 has a buffer with α rows and N columns, where α is the interleaving depth and N is the span of interleaving. FIG. 4 illustrates block interleaving of the buffer having (α*N) symbols.

Phase modulated symbols of the output phasor block x, provided to the block interleaver 32 as a phasor stream input sequence, are written row by row into the buffer. Output sequence from the block interleaver 32 is read out column by column and denoted by x′=[x₁′, . . . , xₖ′, . . . , x_{α*N}].

For example, let the time index k in xₖ be described with k=βN+μ+1 and where 0≦β≦α−1 and 0≦μ≦N−1. After interleaving, the xₖ symbol then occupies the (β+1,μ+1) position in the buffer, where β+1 is the row number and μ+1 is the column number. With reference to FIG. 4, the symbols in the input sequence x=[x₁, . . . , xₖ, . . . , x_{α*N}] and the output sequence x′=[x₁′, xₖ′, . . . , x_{α*N}] have the following relationship,:
x_{βN+μ+1}=x′_{μα+β+1} (14)

An optimum depth of interleaving can be determined from characteristics of the channels 16.

The differential phase encoder 34 then differentially phase encodes the interleaved phase modulated symbols. Output from differential phase encoder 34 is a transmission phasor stream {uₖ}, where
uₖ=uₖ₋₁xₖ′ (15)
where uₒ can be set to 1.

The transmission phasor stream {uₖ} is then mixed with a carrier signal within the transmitting section 20 to derive a modulated carrier signal for transmission on a channel 16. The M-DPSK signals are assumed to be transmitted in a flat, but time-selective Rayleigh fading channel and with additive white Gaussian noise (AWGN).

When received by the receiving section 22, the modulated carrier signal is down-converted to a coded baseband signal. The coded baseband signal in the k-th interval has the complex form
rₖ=\sqrt{γ}fₖuₖ+νₖ (16)
where νₖ is an AWGN sample with zero mean and variance E{νₖνₖ^{*}}=1. γ is the signal to noise ratio (SNR). The sequence {fₖ} is a complex zero-mean Gaussian random variable representing the fading process, which is assumed constant only over one symbol duration and correlated over symbols. The autocorrelation function of fₖ is
E{fₖfₖ₋ₙ*}=ρ_{|n|}=J₀(2πf_{D}T) (17)
where f_{D}T is the maximum Doppler frequency normalized to the symbol rate and J₀(·) is the zero-order Bessel function of the first kind. This fading model is commonly referred to as the land mobile radio model, with the consideration that many multipath waves with identical amplitude arrive at the receiving antenna from all directions with equal probability.

Thereafter, the coded baseband signal is provided to the symbol demodulator 24, which comprises a differential phase detector 36 and a block deinterleaver 38. The differential phase detector 36 processes the rₖ input of the coded baseband signal to derive an output phasor stream zₖ′ based upon the following equation:
zₖ′=rₖrₖ₋₁. (18)
Generally, we can set r₀=1. The block deinterleaver 38 performs a reverse of the interleaving described above with equation (14) above. Deinterleaving recovers the correct order of data from the output phasor stream zₖ′ to obtain a deinterleaved phasor output stream z, where z=[z₁, z₂, . . . . , z_{N}].

The deinterleaved output phasor stream z is then decoded by the decoding section 14, which comprises a Viterbi decoder 40 and a de-mapper 42. For an M-DPSK transmission as applied in this preferred embodiment, symbol decisions are made using a product detector of the Viterbi decoder 40 that computes the following metric:

$$η ( c ) {=}^{Δ} Re \{ {\sum }_{n = 1}^{N} {z}_{n} exp ( j 2 π {c}_{n} / M ) \} \qquad ( 19 )$$

where {zₙ} is decoded to the codeword ĉ such that the corresponding value η(ĉ) is the maxim of all the values {η(c)}.

Hence, for maximum likelihood decoding of the codeword, the computation needed is equal to N2^{N} complex multiplications, (N−1)2^{N} complex additions and (2^{N}−1) comparisons, which is computationally inefficient. On the other had, the independent and equally probable codewords make it possible for a Viterbi algorithm to be employed. The Viterbi algorithm is considered for the preferred embodiment of the invention as applied to decoding of a block-coded modulation signal. The block-coded modulation signal is described using a trellis with metric as defined in equation (19) above.

The task of thee trellis decoder is to estimate the path at the encoded signal sequence traces through the trellis. To constuet the trellis, the procedure is mainly the same as for binary codes, except that the addition and multiplication operations are carried out over the ring Z(M).

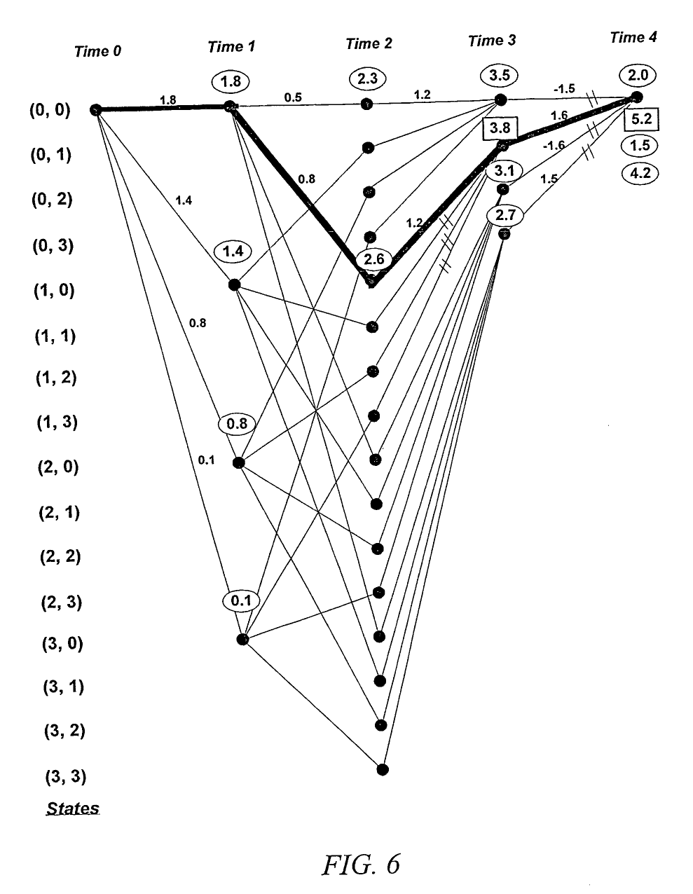

Supposing the transmitted codeword is (0, 1, 13, 8) for the code with the generator matrix G(4, 2) for M=15 used in the above example, then the phasor block x=[x₁, x₂, . . . , x_{N}], xₙ=e^{-j2xc,lM}=(1, 0.9−0.4j, 0.7+0.7j, −1.0+0.2) is provided to the channel 16. To illustrate an actual decoding process, supposing that the received phasor for this phasor block is (1.8+0.5j, 0.5−0.8j, 1.2+0.5j, −1.5+0.5j) after channel impairments caused by Rayleigh fading and AWGN. As shown in FIG. 6, the codeword is correctly decoded by applying Viterbi decoding using equation (19).

From Time 0 to Time 1, the metrics for the four possible branches are:
Re{(1.8+0.5j)·1}=1.8;
Re{(1.8+0.5j)e^{j2π/15}}=1.4;
Re{(1.8+0.5j)e^{j4π/15}}=0.8; and
Re{(1.8+0.5j)e^{j6π/15}}=0.1, respectively.

These metrics are labeled alongside the corresponding branches in FIG. 6. The cumulated metric of the surviving path is labeled as the circled number at each node. As the code was constructed by an input of two message bits and a terminating string of (0,0) into the encoder 28, from Time 2 to Time 3, every four paths must merge, respectively, at states (0 0), (0 1), (0 2) and (0 3). Therefore, it is only necessary to compute the subsequent metrics along the merging paths. The cumulated metric of the surviving path is labeled as numbers in boxes. The Viterbi decoder 40 releases the information sequence of (0 1) as shown by the bolded path of FIG. 6 at the end of the cycle.

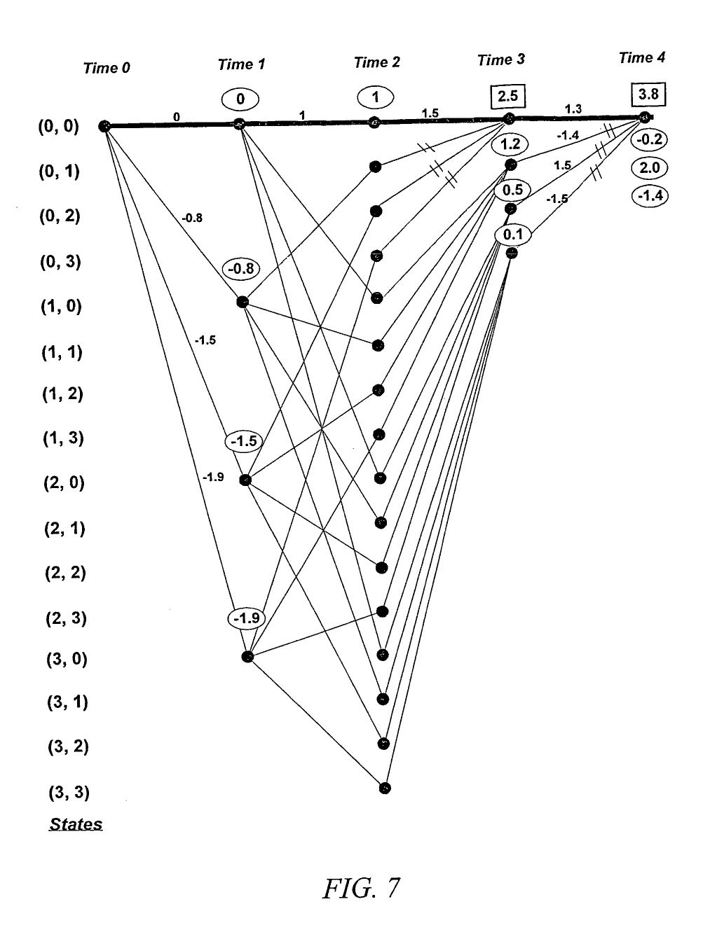

When Rayleigh fading and AWGN impairments are excessive such that received phasor zₙ is (0+2j, 1+0.8j, 1.5−0.5j, 1.3−0.8j), the trellis cannot perform correct decoding. For such a situation, the erroneously decoded sequence is (0, 0) as illustrated with the bolded path in FIG. 7.

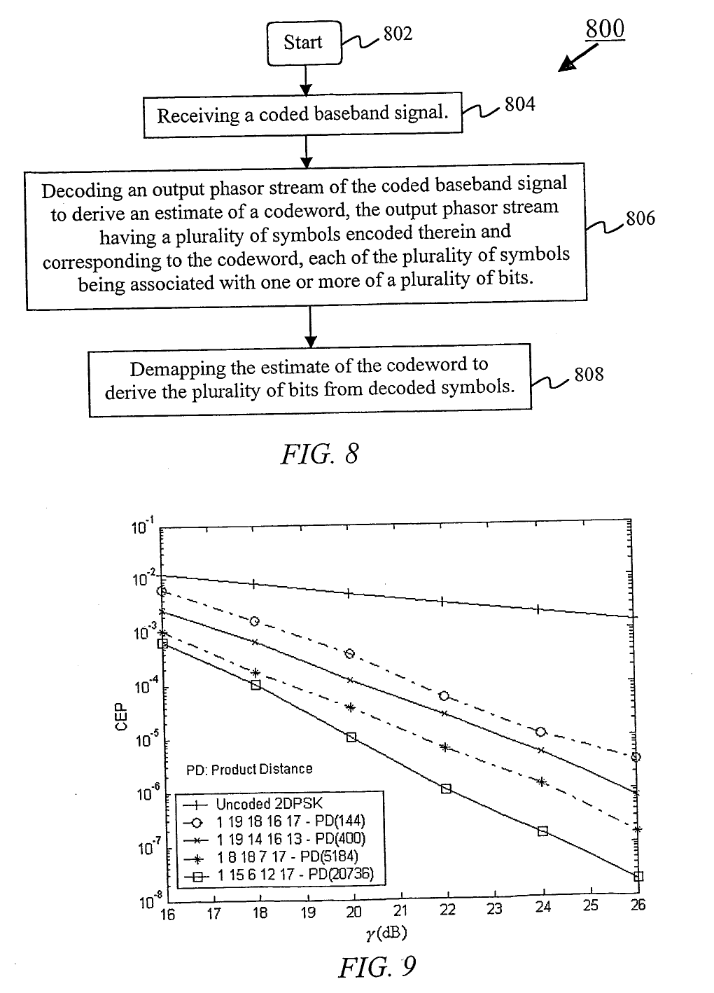

A flowchart of the decoding method 800 to decode a coded baseband signal as described in the above is illustrated in FIG. 8. The method 800 begins at step 802 and proceeds to receiving the coded baseband signal at step 802.

The method 800 then continues to step 806 at which the Viterbi decoder 40 decodes an output phasor stream of the coded baseband signal to derive an estimate of a codeword. The output phasor stream has a plurality of symbols encoded therein that corresponds to the codeword. Each of the plurality of symbols is associated with one or more of a plurality of bits.

Finally, at step 808, the demapper 42 demaps the estimate of the codeword to derive the plurality of bits from decoded symbols receive as output from the Viterbi decoder 40.

Performance of the above coded modulation scheme is determined using code error probability (CEP). The CEP for different lengths of input vectors is obtained through simulation in a Rayleigh fading channel. For such simulation, a correlation coefficient ρ of 0.9997 or f_{D}T=0.0059 is used for the Rayleigh fading channel. The simulation also explores how different values of ρ affects the CEP of codes generated by different polynomials. Before simulation results are provided, distance parameters of codes for the above coded modulation scheme are defined.

Typically, distance parameters of block and convolutional codes are based on the concept of Hamming distance or Euclidean distance. However, the concept of Lee distance is a more natural metric for the above coded modulation scheme. To determine the Lee distance, the Lee weight is first determined. The Lee weight of an n-tuple (a₀, a₁, . . . , aₙ₋₁), aᵢ chosen from the set (0, 1, . . . , M−1), where M is an arbitrary positive integer, is defined as:

$${w}_{L} = {\sum }_{i = 0}^{n - 1} \vert {a}_{i} \vert where \\ \vert {a}_{i} \vert = \{ \begin{matrix}{a}_{i} , & 0 \leq {a}_{i} \leq \frac{M}{2} ; \\ M - {a}_{i} , & \frac{M}{2} < {a}_{i} \leq M - 1\end{matrix} \qquad ( 20 )$$

The Lee distance between two n-tuples is defined as the Lee weight of their difference. The squared Lee distance between i-th components, c₁ᵢ and c₂ᵢ, of two code sequences of length N, c₁ and c₂, in the vector space C, is denoted by d²(c₁ᵢ, c₂ᵢ), which is defined as follows:

$${d}^{2} ( {c}_{1 i} , {c}_{2 i} ) ⩵ \{ \begin{matrix}\vert {c}_{1 i} - {c}_{2 i} \vert , & 0 \leq \vert {c}_{1 i} - {c}_{2 i} \vert \leq \frac{M}{2} \\ M - \vert {c}_{1 i} - {c}_{2 i} \vert , & \frac{M}{2} < \vert {c}_{1 i} - {c}_{2 i} \vert \leq M - 1\end{matrix} \qquad ( 21 )$$

The calculations are performed modulo M.

The product distance between c₁ and c₂, denoted by Δₚ²(c₁,c₂) is defined as follows,

$${Δ}_{p}^{2} ( {c}_{1} , {c}_{2} ) = {\prod }_{i = 1 , {c}_{1 i} \neq {c}_{2 i}}^{N} {d}^{2} ( {c}_{1 i} , {c}_{2 i} ) . \qquad ( 22 )$$

The minimum product distance in C is denoted bye Δₚ²[C] is the minimum product distance between any two code sequences:
Δₚ²[C]=min{Δₚ²(c₁,c₂):c₁, c₂ε C and c₁≠c₂} (23)

As an example, consider the generator matrix G(4,2) for M=15 described earlier. With c₁ as (0 1 13 8), c₂ as (1 13 8 0) and M=15, the three distance measures are calculated, respectively, as follows:

The Lee distance between ith components, c₁ᵢ and c₂ᵢ, of c₁ and c₂
d(c₁₁,c₂₁)=|0−1|_{L}=1
d(c₁₂,c₂₂)=|1−13|·_{L}=3
d(c₁₃,c₂₃)=|13−8|_{L}=5
d(c₁₄,c₂₄)=|8−0|_{L}=7

The squared Lee distance between c₁ and c₂

$${d}^{2} ( {c}_{1} , {c}_{2} ) = {\sum }_{i = 1}^{N} {d}^{2} ( {c}_{1 i} , {c}_{2 i} ) = {1}^{2} + {3}^{2} + {5}^{2} + {7}^{2} = 84$$

The product distance between c₁ and c₂

$${Δ}_{p}^{2} ( {c}_{1} , {c}_{2} ) = {\prod }_{i = 1 , {c}_{1 i} \neq {c}_{2 i}}^{N} {d}^{2} ( {c}_{1 i} , {c}_{2 i} ) = {1}^{2} \cdot {3}^{2} \cdot {5}^{2} \cdot {7}^{2} = 11025$$

After calculating for all the codewords, we find that the distance measures of this (4, 2) code are respectively: d_{L}²(c)=54, Δp²[C]=176.

Generally, for an AWGN channel the error performance of the code depends primarily on its minimum squared Euclidean distance. For a Rayleigh fading channel, the error performance of a code depends primarily on, its minimum product distance.

The CEP for different generator codes is illustratively determined with the following examples:

(1) (8, 4) Codes:

The length of the input vector is taken to be 8 bits long. The mapper 26 slices it into blocks of 2 bits each. The simulations use a fading bandwidth (f_{D}T) of 0.0059 or correlation coefficient ρ=0.9997. For this fade rate of 0.0059, the interleaving depth of 48 T, with T being the symbol interval, is selected, which is approximately around one-fifth to one-quarter the duration of the fade cycle. The fade cycle is define as the reciprocal of the maximum normalized Doppler frequency.

There are various choices on selecting generator polynomials. If M=20=2²×5, then starting from the primitive polynomials over Z(2) and Z(5), the different primitive polynomials over finite fields can be found. The corresponding monic polynomial over Z(4) based on the p-adic expansion of the primitive polynomial over Z(2). Finally the two polynomials over different rings can be combined using the Chinese Remainder Theorem for integers. Since code error performance over fading channels depends primarily on the product distance of a code, the generator polynomials of the (8,4) codes can be selected with larger product distance.

The CEP of the (8, 4) codes generated using different polynomials as a function of signal-to-noise ratio were found for a Rayleigh fading channel and presented in FIG. 9.

As expected, the plot in FIG. 9 shows that the CEP of codes with larger product distance is much better than codes with smaller product distance. There is a notable gain that can be achieved by the above coded modulation scheme for slow Rayleigh fading channels. However, the decoding delay is (N−1)·48 T for each codeword decision. This is a minor setback for applying the above coded modulation scheme to achieve better error performance. In FIG. 9, the bit error probability (BEP) of the uncoded binary differential phase shift keying (BDPSK) transmission in a Rayleigh fading channel is given as:

$${P}_{b} = \frac{1}{2} [ 1 - \frac{ρ γ}{1 + γ} ] \qquad ( 24 )$$

It can be seen that a significant performance improvement over uncoded transmissions can be achieved by using the above coded modulation scheme.

2) (6,2) Codes:

The input data is 6 bits long for such codes. The mapper 26 slices the input data bits into two groups of three bits each. The interleaving depth for these codes is also 48 T seconds. The error performance of (6, 2) codes is shown in FIG. 9. The CEP of codes generated by different polynomials in a Rayleigh fading channel depends primarily on the minimum product distance. The BEP of uncoded BDPSK is plotted in FIG. 9 for comparison.

3) CEP Performance Under Different Correlation Coefficient ρ.

The above simulations use a fading bandwidth (f_{D}T) of 0.0059 or ρ=0.9997. The next simulation determines the CEP of codes generated by different polynomials in Rayleigh fading channel with different fading bandwidths f_{D}T. The correlation coefficient ρ is different for different fading bandwidths f_{D}T.

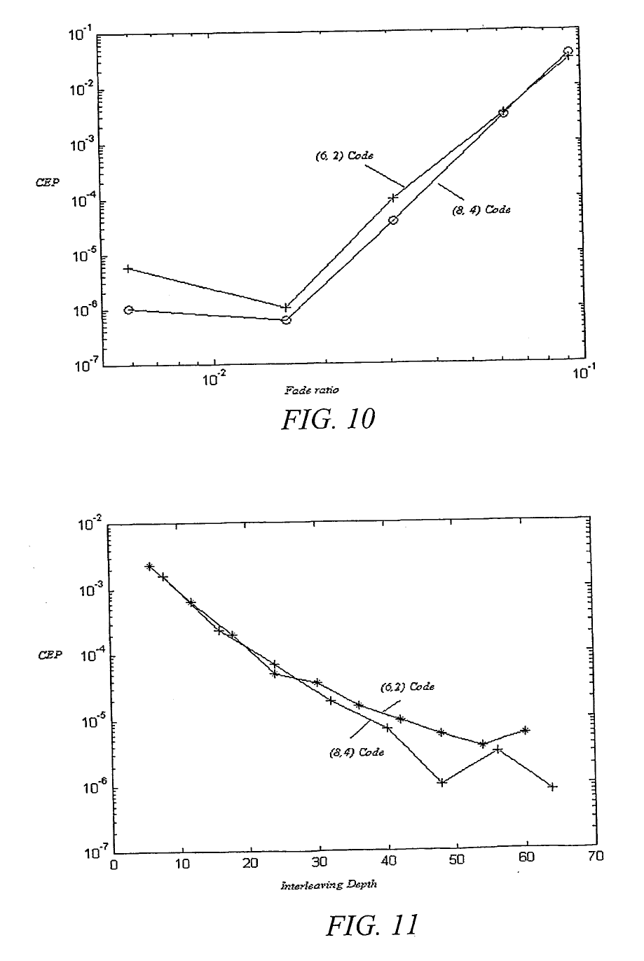

The (8, 4) code generated using polynomials (1 15 6 12 17) and the (6, 2) code generated using polynomials (1 8 2 3 17) are used. For this simulation, the signal-to-noise ratio is fixed at 22 dB. The CEP performance in correlated Rayleigh fading channels with the different correlation coefficient ρ is shown in FIG. 10.

As mentioned earlier, the land mobile model ρ=Jₒ(2πf_{D}T) is used. As indicated in FIG. 10, the CEP depends on the correlation coefficient ρ and thus on the fading bandwidth f_{D}T. As f_{D}T increases (or the channel fades faster) or as ρ decreases, the error increases as expected. However, as f_{D}T decreases and becomes smaller than 0.02, the CEP increases. This is because as f_{D}T decreases, the fade duration increases. If the interleaving is not perfect, the long burst of errors cannot be randomized such that such errors cannot be corrected due to the limited correcting capability of the code.

4) CEP Performance with Different Interleaving Depth α.

In FIG. 11, the CEP performance of the (6, 2) code and the (8, 4) code as a function of interleaving depth is illustrated. The (8, 4) code generated using polynomials (1 15 6 12 17) and the (6, 2) code generated using polynomials (1 8 2 3 17) are used. For his simulation, the signal-to-noise ratio is fixed at 22 dB with correlation coefficient ρ=0.9997. As the interleaving depth ox increases, the CEP of the two polynomials decreases significantly, which indicates that the burst of errors is randomized. However, as the interleaving depth reaches a certain value, any subsequent increase in the interleaving depth does not improve the CEP performance of both codes. Interleaving also increases decoding delay and memory size and, therefore, interleaving depth should be chosen expediently.

It will be appreciated that although one preferred embodiment has been described in detail, various modifications and improvements can be made by a person skilled in the art without departing from the scope of the present invention. For example, the symbol modulator 18 can also be implemented with a frequency shift keying modulator. Further, a coherent phase encoder can be used to encode the interleaved modulated N symbols instead of the differential phase encoder 34.

1. A wireless communication system comprising:
a mapper for mapping a plurality of bits into a plurality of symbols, each of said plurality of symbols being associated with one or more of said plurality of bits;
and
an encoder, coupled to said mapper, for encoding said plurality of symbols to a corresponding plurality of integers modulo M to derive a plurality of coded symbols at said encoder output, said M being an arbiter predetermined integer;
wherein said mapper is adapted to map N binary source bits into N/n symbols over a Z(2ⁿ) ring, said N and n being positive integers and n is a factor of N and;
wherein said encoder is adapted to encode said N/n symbols over said Z(2ⁿ) ring into N coded symbols defined over a Z(M) ring and M>2ⁿ;
further wherein said encoder is adapted to encode said N/n symbols by multiplying said N/n symbols to a generator matrix modulo M;
wherein said generator matrix comprises the coefficients of a generator polynomial; and
wherein said generator polynomial is derived using Chinese Remainder Theorem to combine all primitive polynomials for the ring of each standard factor of said M.

2. The wireless communication system as claimed in claim 1, and further comprising a modulator for modulating said N symbols defined over said Z(M) ring.

3. The wireless communication system as claimed in claim 2, wherein said modulator comprises a phase modulator.

4. The wireless communication system as claimed in claim 2, wherein said modulator comprises a frequency shift keying modulator.

5. The wireless communication system as claimed in claim 2, and her comprising an interleaver for interleaving said modulated N symbols.

6. The wireless communication system as claimed in claim 5, and farther comprising a differential phase encoder for encoding said interleaved modulated N symbols.

7. The wireless communication system as claimed in claim 5, and further comprising a coherent phase encoder for encoding said interleaved modulated N symbols.

8. In a wireless communication system a method for encoding a binary input signal, said method comprising the steps of:
mapping said plurality of bits into a plurality of symbols, each of said plurality of symbols being associated with one or more of said plurality of bits;
and
encoding said plurality of symbols to a corresponding plurality of integers modulo M to derive a plurality of codewords,said M being an arbitrary predetermined integer;
wherein said mapping step further comprises the step of mapping N bits into N/n symbols over a Z(2ⁿ) ring, said N and n being positive integers and n is a factor of N; and
wherein said encoding step Bier comprises the step of encoding said N/n symbols over said Z(2ⁿ) ring into N symbols defined over a Z(M ring and M>2ⁿ,
further wherein said encoding step further comprises the step of multiplying said N/n symbols a generator matrix Modulo M;
wherein said generator matrix is obtained from the coefficients of a generator polynomial; and
wherein said generator polynomial is derived using Chinese Remainder Theorem to combine all primitive polynomials for the ring of each standard factor of said M.

9. The method as claimed in claim 8, and further comprising the step of modulating said N symbols defined over said Z(M) ring.

10. The method as claimed in claim 9, wherein said modulating step comprises the step of phase modulating.

11. The method as claimed in claim 9, wherein said modulating step comprises the step of frequency shift keying modulating.

12. The method as claimed in claim 9, and flier comprising the step of interleaving said modulated N symbols.

13. The method as claimed in claim 12, and further comprising the step of differential phase encoding said interleaved modulated N symbols.

14. The method as claimed in claim 12, and firer comprising the step of coherent phase encoding said interleaved modulated N symbols.

15. The wireless communication system as claimed in claim 1, further comprising
a decoder for decoding an output phasor stream of a coded baseband signal to derive an estimate of a codeword, said output phasor stream having a plurality of symbols encoded therein and corresponding to said codeword, each of said plurality of symbols being associated with one or more of a plurality of bits;
and
a demapper for demapping said estimate of said codeword to derive said plurality of bits from decoded symbols.

16. The wireless communication system as claimed in claim 15, wherein said decoder comprises a Viterbi decoder for decoding over a ring.
